(19) United States
(12) Patent Application Publication
(10) Pub. No.: US 2009/0090142 A1
(43) Pub. Date: Apr. 9, 2009

(54) Locking bag with locking handle

(76) Inventors: Mary Thomson, North East, MD (US); Ann L. Keller, Bensalem, PA (US); Kathleen Parisi, Bensalem, PA (US)

Correspondence Address: FRANK A. MAZZEO, P.C., 808 BETHLEHEM PIKE, SUITE 200, COLMAR, PA, 18915, US

(21) Appl. No.: 11/973,244

(22) Filed: Oct. 5, 2007

(51) Int. Cl. E05B 65/52; A45C 13/10

(52) U.S. Cl. 70/64

(57) ABSTRACT

A bag comprising a lockable pouch and a lockable handle is disclosed. The bag comprises a locking mechanism that secures the contents of the bag by securing a sliding fastener in place. In one embodiment, the handle and sliding fastener are both secured via a common key-operated mechanism. A handle that is removal at one end allows the handle to be placed around a stationary object as to secure the bag to that object while unattended. A single control is provided conveniently to release both the sliding fastener and the handle. The handle is comprised of a flexible yet strong material, such as a metal cable.

### FIELD OF THE INVENTION

The present invention relates generally to apparatus and methods for securing bags and, more particularly, to a bag including a lockable handle.

### BACKGROUND

People use several types of bags, handheld bags, handbags or containers for carrying different personal items with them to stores, beaches, pools, schools, hotels and many other locations. Similarly, students use backpacks to carry laptops, books, media players and other items to and from school. Travelers carry cash, credit cards, cameras, passports, mobile phones and other similar items with them when they travel. These bags or containers contain valuable items that the person does not want to lose or have stolen. Therefore, to ensure that the items are not being removed or stolen from the person's bags, the persons must keep the bags with them at all times. In some situations, carrying the bags at all times becomes burdensome and makes some activities almost impossible.

For example, if a person is at a relatively open area such as a pool or beach and the person has a bag such as a beach bag, tote or purse, the person cannot leave their spot at the pool or beach without taking the bag with them for fear that the bag will be stolen or that one or more items from the bag will be stolen or removed by thieves or the like. The person must therefore carry the bag or purse with them to get food, go to the restroom or to perform other activities such as playing volleyball. In addition, if the person wants to go in the water to swim, the person must have another person such as a spouse watch their bag while they are in the water. Otherwise, the person must place the bag as close to the water as possible to keep an eye on the bag. The additional burdens of watching the bag and carrying the bag makes participation in activities or carrying items such as food trays more difficult.

Thieves operate quickly and discretely. Therefore, a bag that is secured and locked to an object or at least secured and locked in a closed position is a less desirable target for a thief because the thief will have to spend too much time and effort to attempt to remove the bag or to remove the items from the bag. Thieves are less likely to want to draw attention to themselves by trying to cut, pry or break into a secured and locked bag to remove the bag or remove the contents of the bag.

To alleviate the need to carry the bag during an activity, it is desirable to stow the bag in a secure manner. Balancing the need for security is also the need for convenience. The prior art bags are lacking in convenience. Therefore, what is desired, is an improved lockable bag that provides both security and convenience in regular use.

### SUMMARY OF THE INVENTION

The present invention comprises a bag, having a sliding fastener, such as a zipper, and a handle comprising a strong cable. The bag provides the desired security and convenience by providing a bag that can quickly lock or unlock both the handle, and the sliding fastener. The present invention uses a plunger mechanism with a lip to lock the sliding fastener. This technique for locking a sliding fastener is known in the industry, and is the subject of U.S. Pat. No. 5,820,267 to Nobles. While this technique is well suited for locking a sliding fastener, it does not serve to lock a handle. The present invention provides a means to lock both the handle and the sliding fastener. The user may elect to lock the sliding fastener, the handle, or both, depending on the use situation. For example, when carrying the bag, it may be desirable to lock the handle, but leave the sliding fastener unlocked for convenient access to the items contained within the bag. When leaving the bag unattended, it may be desirable to lock both the handle and the sliding fastener to secure the bag, as well as its contents. The handle may be arranged about an object to secure the bag to that object. For example, the handle may be secured around a rail, such as that provided by a fence post, to secure the bag to that rail while it is left unattended. The bag may be secured to a variety of stationary or non-stationary objects, including, but not limited to, a tree, a picnic table, beach umbrella, lounge chair, office desk, baby stroller and shopping cart, to name a few. With the bag of the present invention, the user is able to “lock and leave” the bag and enjoy time with family and friends.

One embodiment of the bag of the present invention includes a unique locking mechanism which secures both a zipper as well as the bag. This embodiment uses a seven pin tumbler, a ⅛″ galvanized coated cable and a liner resistant to cutting and gouging, which makes the bag almost impossible to penetrate by ordinary means. The water-resistant material allows the contents of the bag to remain dry. The design of the zipper/cable locking mechanism is such that the zipper of the bag can remain unlocked allowing easy access to belongings while still maintaining the look of the bag with the shoulder strap in a locked configuration. A bag according to the present invention is well suited for secure transporting of valuables such as cash, credit cards, passports, mobile phones, cameras, computers and media players.

The applications for the bag of the present invention are practically limitless, and include but are not limited to the following: vacation and business travel, water activities, children's activities including sports activities, shopping, activities involving babies, work, school and dorm room security and laptop security. These advantages, and others, will be apparent from the following detailed description.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting.

Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, in some cases both reference numerals and legends (labels, text descriptions) may be used to identify elements. If legends are provided, they are intended merely as an aid to the reader, and should not in any way be interpreted as limiting.

FIG. 1 is a side view of an embodiment of the present invention in a fully locked configuration.

FIG. 2 is a side view of an embodiment of the present invention in a handle locked configuration.

FIG. 3 is a side view of an embodiment of the present invention in an unlocked configuration.

FIG. 4A is a top view of a lock housing.

FIG. 4B is a side view of a lock housing.

FIG. 5 is a perspective view of a lock housing.

FIG. 6 is an illustration of internal components of an embodiment of a lock housing.

FIG. 7 is a side view of an alternative embodiment of the present invention.

FIG. 8 is an illustration of internal components of an alternative embodiment of a lock housing.

### DETAILED DESCRIPTION

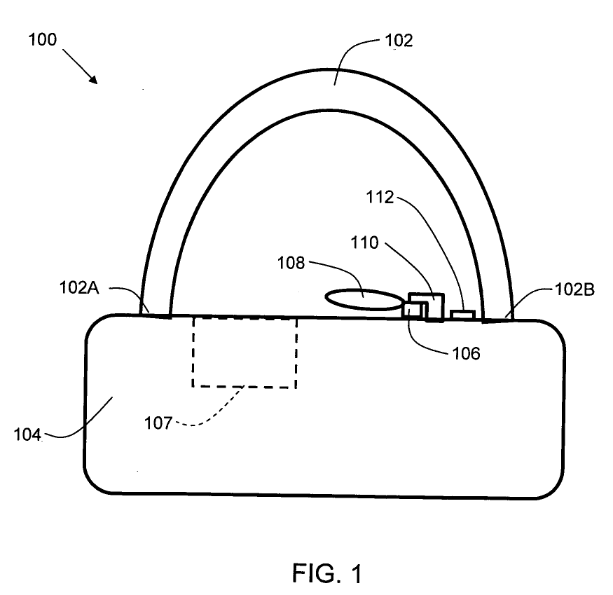

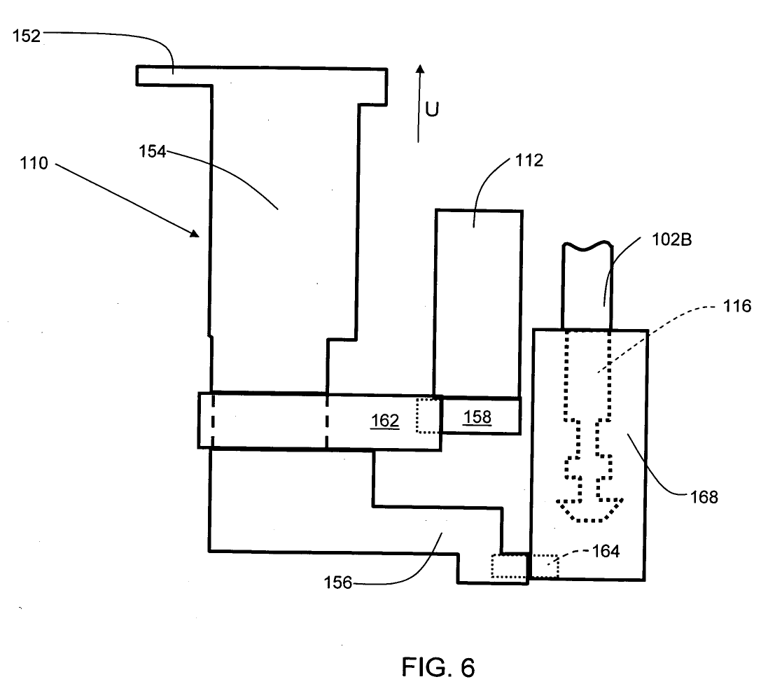

FIG. 1 is a side view of an embodiment 100 of the present invention in a fully locked configuration. The locking bag 100 comprises a handle 102. Handle 102 is comprised of a strong, yet flexible material, such as a metal cable. In a preferred embodiment, the handle 102 is comprised of galvanized steel cable that is coated with plastic, or disposed within a fabric sleeve (not shown). In an exemplary embodiment, a cable of ⅛ inch diameter is used. Handle 102 is secured to pouch 104. Pouch 104 provides the storage capability of locking bag 100. Pouch 104 has an interior space, and an opening (not shown). The pouch 104 is preferably made of a sturdy, water-resistant material, such as a water-resistant polyester fabric that is resistant to cutting and gouging. The material is preferably resistant to cutting and gouging as well. Optionally, one or more interior pockets 107 may be provided within pouch 104. One or more of these interior pockets may be comprised of a waterproof plastic, providing contents contained therein protection from water damage. A lock 112 is used to secure the locking bag 100. In one embodiment of the present invention, the lock is a multiple tumbler key-operated lock (key lock). In an exemplary embodiment, a seven pin tumbler lock is used. Shaft 110 is controlled by lock 112. Shaft 110 (described in more detail in FIG. 6) secures sliding fastener head 106 in place in a “sealing” position, serving to seal pouch 104. In an exemplary embodiment, sliding fastener head 106 is a zipper head. A pull tab 108 is preferably used to move sliding fastener head 106 towards 102A to open the pouch, and allow access to the interior of pouch 104. Alternatively, sliding fastener head is moved towards 102B to seal the pouch. Handle 102 has permanent end 102A and removable end 102B. Handle 102 is permanently secured to pouch 104 at permanent end 102A, and is removable from pouch 104 at removable end 102B.

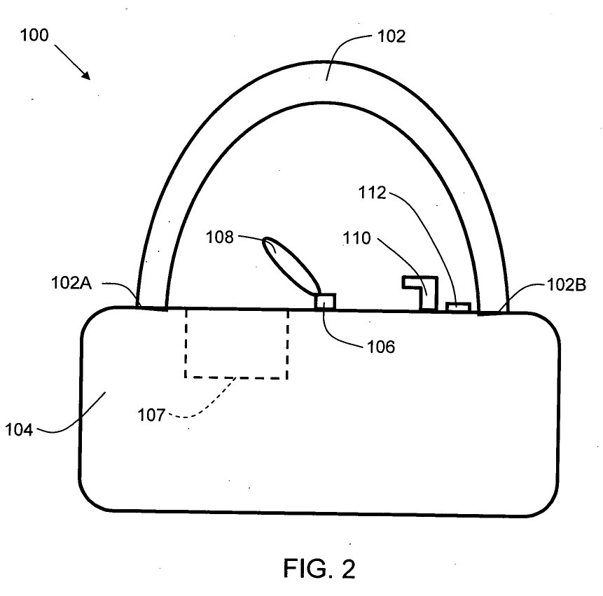

FIG. 2 is a side view of an embodiment 100 of the present invention in a handle locked configuration. In this figure, shaft 110 is extended, as a result of operating lock 112. With shaft 110 extended as shown, sliding fastener head 106 is free to move, hence allowing access to the interior of pouch 104. Handle 102 remains locked, thereby allowing for convenient carrying of locking bag 100.

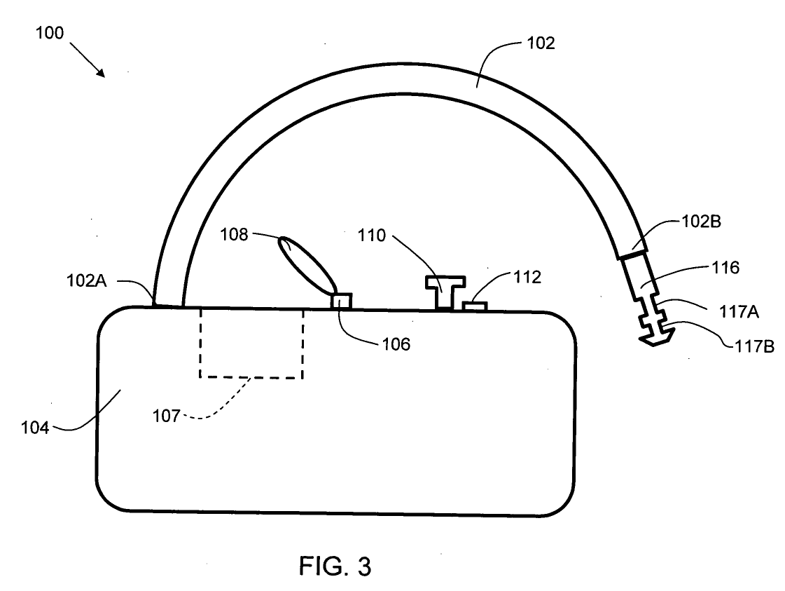

FIG. 3 is a side view of an embodiment 100 of the present invention in an unlocked configuration. In this figure, shaft 110 has been rotated from its position illustrated in FIG. 2. This causes removable end 102B of handle 102 to be released from pouch 104. In this view, handle pin 116 is visible. Handle pin 116 is secured to handle 102 by swaging, or other means to provide a strong attachment. In one embodiment, handle pin 116 comprises a plurality of detents as a means for securing handle pin 116 (and therefore removable end 102B of handle 102) to pouch 104.

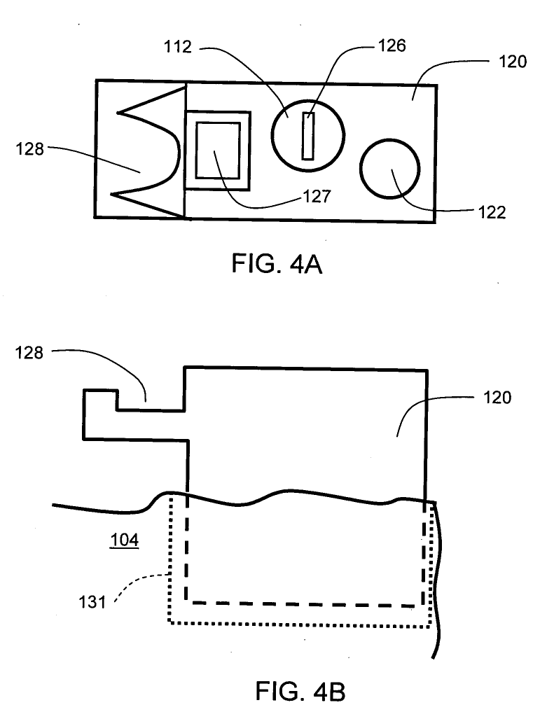

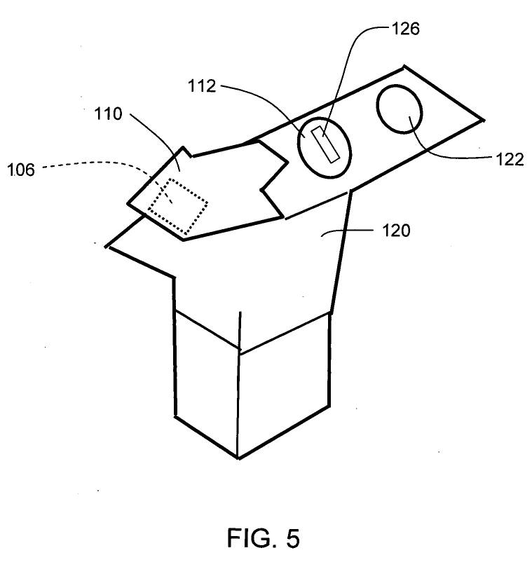

FIGS. 4A, 4B, and 5 show various views of a lock housing 120 in accordance with the present invention. FIG. 4A is a top view of a lock housing, FIG. 4B is a side view of a lock housing, and FIG. 5 is a perspective view of a lock housing. Lock housing 120 is preferably secured in a reinforcing panel 131 that is folded and sewn around the lock to hold it in place. Lock housing 120 comprises pin port 122. Pin port 122 receives handle pin 116 in order to secure handle 102 to pouch 104. Lock 112 comprising key slot 126 is located between pin port 122 and shaft opening 127. Fastener head slot 128 is used to secure sliding fastener head 106 in order to secure contents within pouch 104. FIG. 4B illustrates that a portion of lock housing 120 is concealed by pouch 104. FIG. 5 illustrates a perspective view of the lock housing 120, showing a view of shaft 110 from above. To secure the contents of pouch 104, sliding fastener head 106 is positioned in fastener head slot 128, and under the head (see FIG. 6 for more detail) of shaft 110.

FIG. 6 is an illustration of internal components of lock housing 120. In this illustration, various parts of shaft 110 are illustrated in further detail. Shaft 110 comprises shaft head 152, elongated portion 154, and barrel paddle 156. Lock 112 has engaging member 158 that engages shaft release mechanism 162, which allows shaft 110 to extend in a “vertical” direction indicated by arrow U, to unlock the sliding fastener head 106. Once extended, a user can rotate shaft 110 about its elongated axis by turning shaft head 152 with his hand. Turning shaft head 152 causes barrel paddle 156 to engage pin release mechanism 164, which causes handle pin 116 to be released from pin housing 168 via a spring mechanism (not shown). For the sake of clarity, not all details of the engaging and releasing mechanisms are shown. However, mechanisms to engage and release a pin from a pin housing are known in the industry, and to one of ordinary skill in this art.

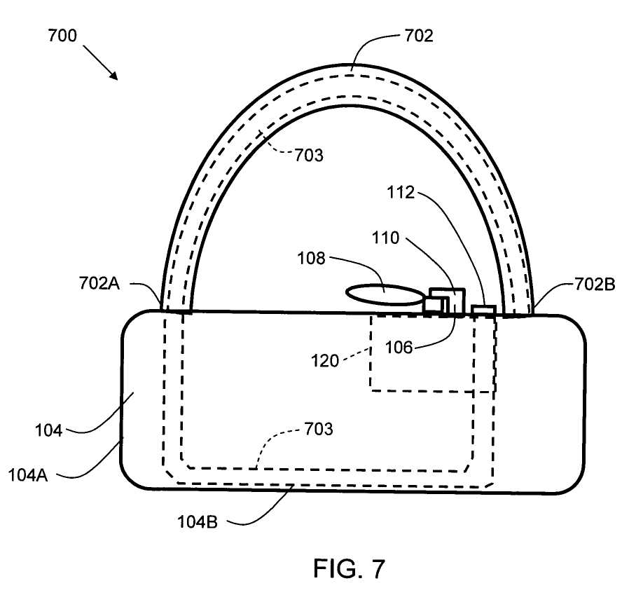

FIG. 7 is a side view of an alternative embodiment 700 of the present invention. This embodiment is similar to that shown in FIG. 1, except that handle 702 has cable 703 contained within handle 702. The cable 703 is preferably sewn into the handle 702, providing improved strength for the handle. Cable 703 extends into the interior of pouch 104, and is secured to the interior of the pouch along side 104A of the pouch 104, then along the bottom of the pouch (104B), and then travels upward, and secures to lock housing 120. This provides for additional security by reinforcing the attachment of handle 702 to pouch 104.

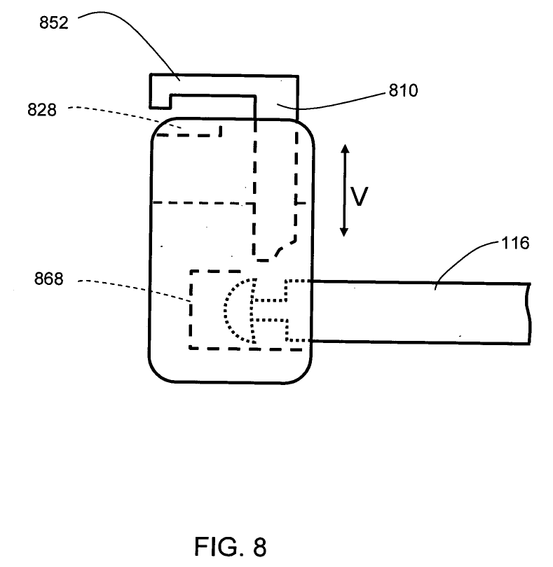

FIG. 8 is an illustration of internal components of an alternative embodiment of a lock housing. In this embodiment, shaft 810 is operated similar to the operation of shaft 110 as described for FIG. 6. However, in this embodiment, handle pin 116 is oriented at a substantially right angle to the shaft 810, and is secured within pin housing 868. The shaft 810 is movable in the direction indicated by arrow V. Shaft 810 has shaft head 852 which secures a fastener head (not shown) in fastener head slot 828 when the present invention is in a locked configuration.

It will be understood that the present invention may have various other embodiments. Furthermore, while the form of the invention herein shown and described constitutes a preferred embodiment of the invention, it is not intended to illustrate all possible forms thereof. It will also be understood that the words used are words of description rather than limitation, and that various changes may be made without departing from the spirit and scope of the invention disclosed. Thus, the scope of the invention should be determined by the appended claims and their legal equivalents, rather than solely by the examples given.

What is claimed is:

1. A locking bag comprising:
a pouch defining an interior space and an opening;
a sliding fastener, comprising a sliding fastener head, the sliding fastener configured and disposed to seal the pouch;
a handle having a first end, and a second end, the first end permanently secured to the pouch, and the second end removably secured to the pouch, the second end comprising a handle pin;
a lock housing, the lock housing comprising a pin port, a lock, and a shaft, the shaft comprising an elongated portion, a shaft head at a first end of the elongated portion, and a barrel paddle at a second end of the elongated portion; whereby the shaft is configured and disposed to travel in a vertical direction, the shaft also configured and disposed to be rotated about the elongated axis of the shaft, thereby providing means for securing the handle to the pouch, and providing means for securing the sliding fastener head in a sealing position on the pouch.

2. The locking bag of claim 1, wherein the sliding fastener further comprises a pull tab attached to the sliding fastener head.

3. The locking bag of claim 2, wherein the sliding fastener is a zipper.

4. The locking bag of claim 1, wherein the handle is comprised of a cable.

5. The locking bag of claim 4, wherein the cable is comprised of steel.

6. The locking bag of claim 5, wherein the cable is coated with plastic.

7. The locking bag of claim 1, wherein the handle extends into the interior of the pouch, and is secured to the interior of the pouch along a first side of the pouch, the handle also secured along the bottom of the pouch, and the handle also secured along a second side of the pouch.

8. The locking bag of claim 1, wherein the pouch is comprised of polyester fabric.

9. The locking bag of claim 1, wherein the pouch is resistant to cutting or gouging.

10. The locking bag of claim 1, wherein the handle pin comprises a plurality of detents.

11. The locking bag of claim 1, wherein the lock is a key-operated lock.

12. The locking bag of claim 10, wherein the lock comprises seven tumblers.

13. The locking bag of claim 1, wherein the lock housing is secured in a reinforcing panel, the reinforcing panel sewn around the lock, thereby serving to hold the lock housing in place.

14. The locking bag of claim 10, wherein the lock housing further comprises a pin housing, the pin housing configured and disposed to engage the plurality of detents of the handle pin, thereby securing the handle pin within the pin housing.

15. The locking bag of claim 1, wherein the lock housing further comprises a fastener head slot, whereby the sliding fastener head is positioned within the fastener head slot when the sliding fastener head is secured in a sealing position.

16. A locking bag comprising:
a pouch defining an interior space and an opening;
a sliding fastener, comprising a sliding fastener head, the sliding fastener configured and disposed to seal the pouch;
a handle having a first end, and a second end, the first end permanently secured to the pouch, and the second end removably secured to the pouch, the second end comprising a handle pin;
a lock housing, the lock housing comprising a pin port, a lock, and a shaft, the shaft comprising an elongated portion, and a shaft head at a first end of the elongated portion;
whereby the shaft is configured and disposed to travel in a vertical direction, and the pin port is disposed in a horizontal direction, whereby the pin port is at a substantially right angle to the shaft.

17. A method of securing and locking a bag, the bag comprising locking bag comprising:
a pouch defining an interior space and an opening;
a sliding fastener, comprising a sliding fastener head, the sliding fastener configured and disposed to seal the pouch;
a handle having a first end, and a second end, the first end permanently secured to the pouch, and the second end removably secured to the pouch, the second end comprising a handle pin;
a lock housing, the lock housing comprising a pin port, a key lock, a sliding fastener head slot, and a shaft, the shaft comprising an elongated portion, a shaft head at a first end of the elongated portion, and a barrel paddle at a second end of the elongated portion;
whereby the shaft is configured and disposed to travel in a vertical direction, the shaft also configured and disposed to be rotated about the elongated axis of the shaft, thereby providing means for securing the handle to the pouch, and providing means for securing the sliding fastener head in a sealing position on the pouch, the method comprising the steps of:
inserting the handle pin into the pin port, thereby securing it to the pouch;
sliding the sliding fastener head into the sliding fastener head slot; and
depressing the shaft, thereby securing the sliding fastener head within the sliding fastener head slot.

18. The method of claim 17, further comprising the step of arranging the handle about an object prior to inserting the handle pin into the pin port, thereby securing the bag to the object.

19. The method of claim 17, further comprising the step of unlocking the bag, wherein the step of unlocking the bag comprises the steps of:
inserting a key in the key lock; and
turning the key, thereby extending the shaft, and releasing the sliding fastener head.

20. The method of claim 19, further comprising the step of releasing the handle, wherein the step of releasing the handle comprises rotating the shaft, thereby releasing the handle pin from the pin port.
